(19) United States
(12) Patent Application Publication
(10) Pub. No.: US 2006/0129385 A1
(43) Pub. Date: Jun. 15, 2006

(54) Cholinergic therapy for individuals with learning disabilities

(76) Inventors: James H Heller, Chapel Hill, NC (US); Priva Kishnani, Durham, NC (US); Gail A Spiridigliozzi, Durham, NC (US); Gordon Worley, Chapel Hill, NC (US)

Correspondence Address: BANNER & WITCOFF, 1001 G STREET N W, SUITE 1100, WASHINGTON, DC, 20001, US

(21) Appl. No.: 10/522,013

(22) PCT Filed: Jul. 22, 2003
(86) PCT No.: PCT/US03/22746

§ 371 Date: Oct. 7, 2005

(30) Foreign Application Priority Data
Jul. 22, 2002 (US) 60397123

(51) Int. Cl. G10L 11/00

(52) U.S. Cl. 704/200

(57) ABSTRACT

Cholinergic agents are used to improve specific learning deficits and language function in individuals of normal intelligence. Psychosocial deficits including a pragmatics impairment, reading deficits, a problem solving impairment, an information processing impairment, an adaptive function impairment, social skills impairment, attention impairment, a mood impairment and employment skills impairment, can also be treated in this manner. The cholinergic treatments can be combined with more traditional educational, psychological, and behavioral therapies for enhanced therapeutic benefit.

This application claims the benefit of provisional application Ser. No. 60/397,123 filed Jul. 22, 2002, the disclosure of which is expressly incorporated herein.

### BACKGROUND OF THE INVENTION

1. Field of the Invention

The invention relates to the treatment of conditions that lead to language deficits and specific learning disabilities.

2. Background of the Prior Art

Cholinergic treatment (specifically, donepezil hydrochloride) can improve language performance, adaptive function, and verbal memory in individuals with Down syndrome (DS), the most common form of mental retardation.

When properly diagnosed, children and adults with language/reading deficits or with specific learning disabilities often receive extensive therapy and/or special educational services that are provided at a generally high cost to the individual, the family, and/or school system. In most cases (especially for older children and adults), the focus of intervention services is on compensating for the learning problem(s) rather than addressing the underlying neurologic cause of the problem. Language learning disabilities and reading learning disabilities are the most common forms of learning disability (Velluntino, 1979). Prevalence estimates of these learning disabilities vary from as few as 5% of the population to as many as 25% of children with some degree of learning disability (Richman, 1983), although studies of language impairment suggest that 8 to 10% of the population may be a more accurate estimate (Williams, et al., 1980 and Beitchman, et al., 1986).

There is a need in the art for pharmacological interventions for language deficits (including language-based reading deficits) and specific learning disabilities that can be provided at reduced cost to the individual, the family, and the school system.

### BRIEF SUMMARY OF THE INVENTION

According to one embodiment of the invention a dose of an agent which increases acetyl choline or butyryl choline levels in brain is prescribed for human subjects who have a language information processing deficit relative to normal individuals, and do not have Down's Syndrome, schizophrenia, attention deficit hyperactivity disorder, Alzheimer's disease, Parkinson's disease, head injury, dementia, memory deficit, Wernicke-Korsakoff's disease, Tardive Diskenesia, vascular dementia, or depression. The prescribed dose is effective to increase specific domains of language performance or learning/academic performance.

According to another embodiment of the invention a dose of an agent which increases acetyl choline or butyryl choline levels in brain is administered to a human subject who has a language information processing deficit relative to normal individuals, and does not have Down's Syndrome, schizophrenia, attention deficit hyperactivity disorder, Alzheimer's disease, Parkinson's disease, head injury, dementia, memory deficit, Wernicke-Korsakoff s disease, Tardive Diskenesia, vascular dementia, or depression. The administered dose is effective to increase specific domains of language performance or learning/academic performance.

Another embodiment of the invention is a kit for treating human subjects who have a language information processing deficit relative to normal individuals, and do not have Down's Syndrome, schizophrenia, attention deficit hyperactivity disorder, Alzheimer's disease, Parkinson's disease, head injury, dementia, memory deficit, Wernicke-Korsakoff's disease, Tardive Diskenesia, vascular dementia, or depression. The kit contains one or more divided or undivided doses of an agent which increases acetyl choline or butyryl choline levels in the brain. The doses are effective to improve specific domains of language performance in human subjects. The kit also contains printed instructions for prescribing or administering the cholinergic agent to improve specific domains of language performance in human subjects The invention thus provides the art with a new battery of pharmacological treatments for addressing learning, language, and other psychosocial impairments which have a neurological basis.

### BRIEF DESCRIPTION OF THE DRAWINGS

FIG. 1 shows High language (High Lang) and Low language (Low Lang) group performance by CELF-R subtest at baseline (Base) and at study termination (Treat).

FIG. 2 shows a comparison of language performance at Baseline and at Treatment for each language measure. Baseline and Treatment values are group average raw score performance (n=5). The statistical significance of the difference in Baseline and Treatment performance is determined by a paired t test. Indices of clinical significance, i.e. average performance and the range in raw scores for 5-year-olds, and the average improvement in raw score performance as children age from 5 to 6 years old, are provided.

FIG. 3 shows a comparison of High Language (n=2) and Low Language (n=3) group performance at Baseline and at Treatment by language measure. Baseline and Treatment values are group average raw score performance. Indices of clinical significance, i.e. average performance and the range in raw scores for 5-year-olds and the average improvement in raw score performance as children age from 5 to 6 years old, are provided.

### DETAILED DESCRIPTION OF THE INVENTION

Cholinergic therapy for children and adults with a language information processing deficit is an effective treatment of underlying disability. Related psychosocial disabilities, such as reading impairment, pragmatics impairment, problem solving impairment, information processing impairment, adaptive function impairment, social skills impairment, attention impairment, mood impairment, and employment performance limitations can be similarly or concomitantly treated successfully. Such treatment affects the underlying neurological cause of learning, language, and psychosocial problems. Moreover, it can be used in conjunction with traditional educational and psychological treatments to enhance the therapeutic benefits.

The most widely accepted definition of learning disability is provided by the Individuals with Disabilities Education Act (IDEA; Public Law 105 17) that is the basis for state and federal finding for children with special learning needs. PL 105 17 defines a specific learning disability as:
Those children who have a disorder in one or more of the basic psychological processes involv in understanding or in using language, spoken or written, which disorder may manifest itself in imperfect ability to listen, think speak, read, write, spell, or do mathematical calculations. Such disorders include such conditions as perceptual handicaps, brain injury, minimal brain dysfunction, dyslexia, and developmental aphasia. Such term does not include children who has learning problems that are primarily the result of visual, hearing, or motor handicaps, of mental retardation, of emotional disturbance or environmental, cultural, or economic disadvantage.

34- CFR part 300(c) (10)j.

Aphasia is a distinct clinical syndrome. It is characterized by a child or adult who shows a relatively specific failure of normal language functions in the absence of the factors that often provide the general setting in which failure of language is usually observed: deafness, mental deficiency, motor disability, or severe personality disorder. The failure can manifest itself either as a disability in expressive language only, with near normal receptive language, or as a disability in both receptive and expressive language. It has been suggested that certain developmental language disorders and developmental reading disorders may result from the same underlying neurological deficit and may differ only in the age of the child and in the learning skills being acquired at different ages (Tallal, 1988).

PL 105 17 also defines speech or language impairment as a separate condition:
Speech or language impairment means a communication disorder such as stuttering, impaired articulation, language impairment, or a voice impairment that adversely affects a child's educational performance.

34- CFR part 300(c) (11)J.

Conditions which can be successfully treated according to the present invention include specific learning disability, a language or reading impairment, a pragmatics impairment, a problem solving impairment, an information processing impairment, an adaptive function impairment, social skills impairment, attention impairment, employment skills impairment, and mood impairment. Methods for diagnosing and measuring these conditions are known in the art. The Test of Problem Solving [Zachman et al., 1984] and the Clinical Evaluation of Language Fundamentals-Revised [Semel et al., 1986] can be used to objectively measure language performance. Other tests can be used as determined in the art.

Doses of agents which increase the levels of brain acetyl choline or butyryl choline will depend on the strength and potency of the agents. Typical dosages for cholinesterase inhibitors currently on the market are in the ranges of 1 to 10 mg/day, 10 to 160 mg/day, 0.5 to 15 mg/day, and 1-25 mg/day, for donepezil, tacrine, rivastigmine, and galantamine, respectively. The useful agents can be, for example, cholinergic agonists, muscarinic receptor agonists, and nicotinic receptor agonists. The agents can be administered in divided doses over the course of a day or once per day, depending on the tolerance and metabolism of the drugs.

Treatment with cholinergic agents of individuals who are mentally retarded and individuals who are not mentally retarded improves conditions that lead to language deficits and specific learning disabilities. Thus individuals at all intelligence levels, including normal to superior intelligence measures, can achieve language, learning, and other neurologically based psychosocial benefits by treatment with such agents. Individuals who can be beneficially treated include those with IQ measurements of at least 70, at least 80, at least 85, at least 90, at least 95, and at least 100, as measured using either the Wechsler Intelligence Scale for Children of the Wechsler Adult Intelligence Scale, for children and adults, respectively. Individuals with lower IQs without Downs's Syndrome can also be treated to good effect. Such individuals include those with a chromosome 22q terminal deletion, Angelmann Syndrome, Fragile X Syndrome, Rett Syndrome, Spina bifida, and Williams Syndrome. Other chromosomal disorders are also associated with learning disabilities and language information processing deficits. Such disorders include trisomy, monosomy, translocations, and abnormal numbers of triplet repeats. Patients with such disorders can be treated according to the present invention.

Prescription of the treatments of the present invention is typically done following diagnostic testing and result interpretation. The diagnostic testing and prescription need not be done by the same entity. Patients who are already receiving some behavioral, educational, or other non-pharmacological intervention can be treated with the pharmacological agents according to the present invention. Alternatively a physician may prescribe and/or administer both a behavioral, educational, or other non-pharmacological intervention and a pharmacological agent according to the present invention. Tests which are used diagnostically can also be used to monitor the efficacy of treatments.

The pharmacological agents can be administered according to any approved route, including intravenous, subcutaneous, and intramuscular injections, as well as oral or nasal administrations. The agents can be self-administered or administered by a medical professional or other third party, such as a parent or other caregiver.

Printed instructions for a kit according to the invention include any written instructions. The instructions may be on a package insert, on a carton or bottle, or on an electronic medium, such as a compact disk. The instructions may constitute a reference citation, referring the practitioner to an internet site or other reference source which is not actually contained within the kit. Any instructions, whether verbal or pictorial, whether virtual or actual, can be used in the kit.

### EXAMPLES

In the current study, we specifically examined the effects of donepezil and tested the hypothesis that expressive language performance in individuals with Down's Syndrome would improve with donepezil treatment. Language performance was measured with two objective measures, the Test of Problem Solving [Zachman et al., 1984] and the Clinical Evaluation of Language Fundamentals-Revised [Semel et al., 1986].

### Method

Subjects: After obtaining IRB approval and written informed consent, 5 males and 1 female with DS (confirmed by karyotyping), between the ages of 20-41 years (mean age=29 years), were enrolled in the trial. All subjects were verbal, able to hear speech at conversational level, and able to ingest oral medication. None of the subjects had a clinical diagnosis of dementia (DSM-IV criteria), a recent history of sudden decline in life skills, clinically confirmed pregnancy, or clinically significant systemic disorders [e.g. bradycardia (HR<50), insulin-dependent diabetes mellitus, active peptic ulcer, celiac disease, significant reactive airways, and seizure disorder]. All individuals were evaluated for thyroid disorders and for Vitamin B 12 deficiency within 6 months of entry into the trial. They had not previously participated in a trial using cholinesterase inhibitors or had ingested any other investigational or alternative therapies that are used specifically to treat the symptoms of DS (e.g. mega-vitamins, piracetam, Nutrivene-D, MSB plus) in the 30 days prior to or during the trial. Subject IQs ranged from 40 to 60 (mean IQ=52). The IQs of four subjects were determined during the baseline visit because testing had not been performed in the last 10 years. The IQ's of the two youngest subjects were determined from school records.

Study Design: This was a 24 week open study at the General Clinical Outpatient Research Unit at Duke University in which subjects attended three sessions, Week 0 (Baseline), Week 12 (Treatment-12), and Week 24 (Termination). Due to scheduling limitations, the average first post-treatment visit was at Week 13 and the second post-treatment visit was at Week 25. A physical exam and language testing were completed at all sessions. A checklist for medication related adverse events was performed at Week 12 and at study termination. At the completion of the Baseline visit, donepezil was dosed orally at 5 mg once daily for 6 weeks. The dose was increased to 10 mg (two 5 mg tablets) daily for the remaining weeks if the 5 mg dose was well tolerated. This dosage schedule was based on experience from a previous trial [Kishnani et al 1999] and the donepezil package insert. Patients were monitored closely for safety and tolerability of the medication by regular phone calls in between scheduled visits. Two language measures were used, the Test of Problem Solving (TOPS) and the Clinical Evaluation of Language Fundamentals-Revised (CELF-R). The TOPS was completed at Baseline and at Weeks 12 and 24 of treatment. The CELF-R was completed at Baseline and at Week 24.

Measures: The Test of Problem Solving [TOPS: Zachman et al., 1984]: The TOPS is an expressive language test that measures the ability to verbally identify reasonable solutions to problems presented via pictures. It has been used to assess pragmatic language ability in patients with AD. [Ripich et al., 1997]. The TOPS consists of 15 pictured scenarios with accompanying questions about each picture. The standard set of questions is designed to have the subject make inferences, to determine causes of particular events, to determine solutions to pictured problems, and to determine strategies for avoiding problems. The instrument was standardized on 1578 individuals (ages 6 years-0 months to 11 years-11 months). Age equivalent scores are provided for ages 3 years-5 months to 15 years-9 months. Validity and reliability data are available. TOPS raw scores for the overall [test as recommended by Powell, 1993] were determined by the average of two independent observers, one scoring onsite and a second scoring from audiotaped recordings of the test sessions.

The Clinical Evaluation of Language Fundamentals-Revised (CELF-R: Semel et al., 1986]: The CELF-R is a diagnostic language test designed to assess language form and content, aspects of language generally regarded as fundamental to effective, oral—communication. Standardized expressive, receptive and overall language scores are derived from the summation of individual subtest scores. Typically, overall expressive and receptive language are evaluated by collapsing the subtest performance into a single receptive: or expressive language score. Individual subtest performance is analyzed for specific impairment within the broader expressive and receptive language domains. The instrument was standardized on 2,333 individuals (ages 5-0 to 16-11). Validity and reliability norms are available and adequate for each subtest.

Derivation of Language Level: Due to the absence of appropriate standardized measures for adults with DS, relative language level was determined by comparing subtest performance (raw scores) to the average performance level for five-year-olds. The five year-old level was selected because it is the lowest age level in which both tests provide normative data. For this study, TOPS performance was based on age equivalent scores.

Clinical Significance of Change: The clinical significance of the change in language performance following treatment was determined by comparing the difference in subject performance (between Baseline and treatment) to the amount of language improvement shown in one year by the average 5-year-old. For the TOPS, this index was the difference between the age equivalent score for children aged 5 years-0 months and the age equivalent score for children aged 6 years-0 months. For the CELF-R subtests, this index was difference between the mean raw scores for 5 year-olds and 6-year-olds.

Statistical Analyses: The main comparisons were changes from Baseline (week 0) assessed by repeated measures. Because of the preliminary and exploratory nature of the study, we did not correct for multiple comparisons. Similarly, while we hypothesized an improvement in expressive language, the acceptable p-value was not adjusted to reflect a one-tailed analysis. P-values at or below 0.05 were viewed as significant. Changes on standardized measures were viewed as clinically significant if the magnitude of the observed change was substantial in comparison to the level of performance gain typically achieved by children in the 12 month period between age 5 and age 6. Across all measures, the performance gain between age 5 and age 6 is the highest rate of language gain recorded for any 12-month period.

### Results

Overall, all subjects tolerated donepezil relatively well. All patients were increased from the 5 to 10 mg dose after 6 weeks. Five of six subjects experienced mild cases of diarrhea at the 5 mg dosage. Each case improved spontaneously. One subject reported cramps for one day and one subject reported a transient decrease in appetite on the 10 mg dosage. All subjects completed the study.

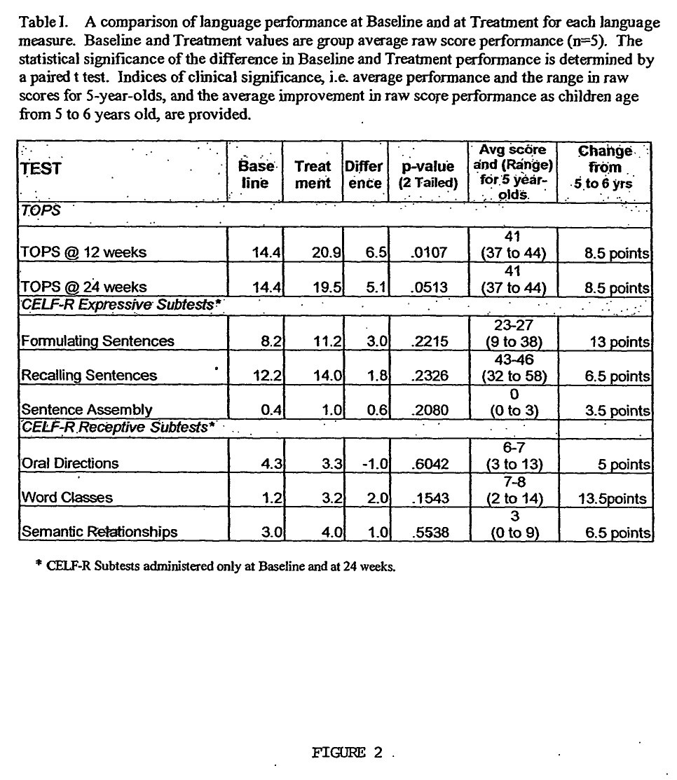

One subject was excluded from the TOPS analysis because of a missing baseline value and a second subject was excluded from the CELF-R analysis because a different version of the test (CELF-3) was administered inadvertently. At Baseline, the subjects scored below the 5-year-old range on most language measures (FIG. 2). They scored within the range on only 3 of 6 CELF-R subtests (Sentence Assembly, Oral Directions, and Semantic Relationships).

Following 12 weeks of treatment, the subjects demonstrated significantly improved performance on the TOPS (Baseline vs. Treatment-12 weeks paired samples t=4.5; p=0.0107). No change in TOPS performance was noted after 12 additional weeks of treatment [Treatment-12 weeks vs. Termination (24 weeks of treatment) paired samples t=0.52; p=0.6313]. The overall TOPS performance gain was 6.5 after 12 weeks and 5.1 after 24 weeks (Baseline vs. Termination paired samples t=1.10; p=0.0513). In terms of clinical significance, the overall performance gain after treatment was more than one-half of the gain expected by the average five-year-old in one year of development.

Following 24 weeks of donepezil treatment the subjects showed gains in 5 of 6 of the CELF-R subtests (FIG. 2). None of the differences was significantly different from baseline levels. Improvement approached significance (i.e., p=0.15-0.23) in all three expressive subtests and one receptive subtest (Word Classes).

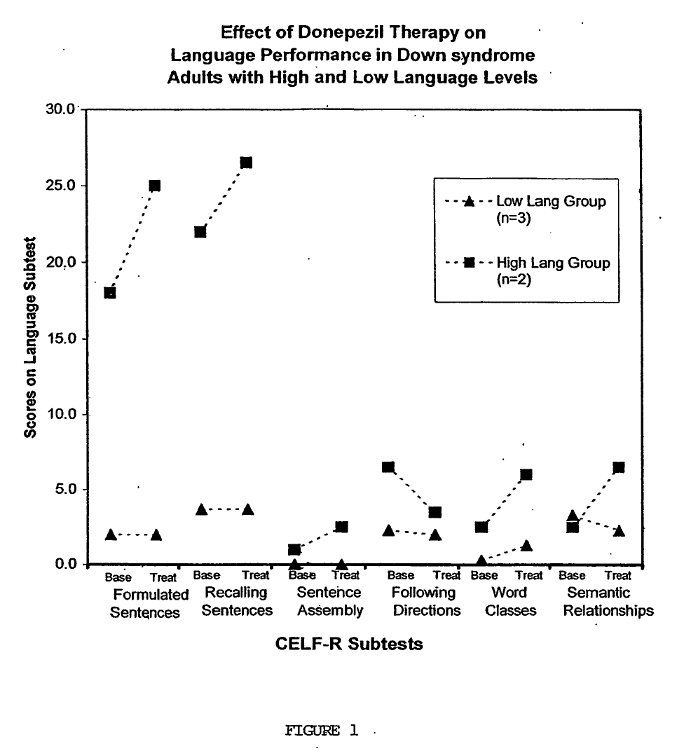

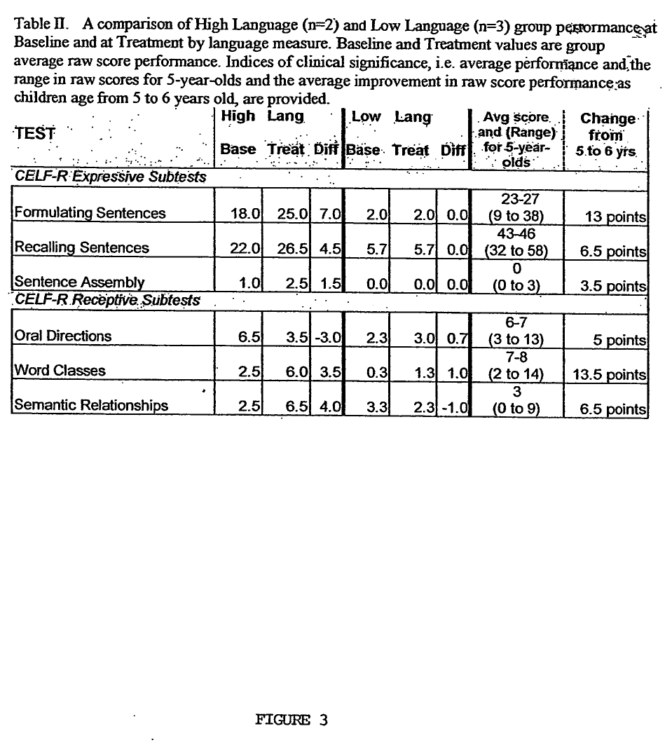

An analysis of individual performance on the CELF-R revealed two different language performance patterns (FIGS. 1 and 3). Individuals with higher language skills at Baseline (High Language Group, n=2) tended to show large gains in language performance on the CELF-R subtests following treatment, whereas individuals with lower language skills at Baseline (Low Language Group, n=3) showed little gain on the CELF-R language measures. Almost all of the performance gain on the CELF-R subtests reflected in the group data (FIG. 2) can be attributed to two subjects. This was in contrast with the TOPS performance where all subjects showed improvement following treatment.

### Discussion

To our knowledge, this is the first prospective study to systematically evaluate the effects of donepezil on specific language domains in DS over 24 weeks. The primary finding that emerged was an improvement in the expressive language performance (specifically, the TOPS) of adults with DS following donepezil therapy. The magnitude of the gain was more than one-half of the typical one-year improvement in developmental language function experienced by five-year-olds, a period of rapid language gain.

The CELF-R provided comparable results. Of the four subtests yielding treatment effects that approached significance (p=0.15-0.23), three were expressive subtests and only one, Word Classes, was a receptive language measure. It can be argued that the Word Classes subtest may not be a pure measure of receptive language, because it requires a verbal response. Word Classes was the only CELF-R subtest in which both High Language and Low Language groups showed improved performance with treatment.

The discrepancy in treatment effect between the High Language and Low Language groups on all other CELF-R subtests is important to consider in light of reports [Miller, 1988; Fowler, 1988] of differential language performance abilities in children with DS. Miller [1988] identified two patterns of language development in children with DS, a flat profile where cognition, language production, and language comprehension are equivalent, and a profile of specific delay in language production. He suggested that these developmental differences were caused by neurologic differences in the two groups of children. Similarly, Fowler [1988] suggested that IQ plays a substantial role in determining the prognosis of language learning in children with DS. She concluded that an IQ level of greater than 50 is critical to assuring substantial growth when maturational factors permit it. In the present study, language performance at baseline, and the treatment effect appeared to be related to IQ. The IQs of the High Language group were both 60, whereas the IQs of the Low Language group ranged from 40 to 53.

In addition to the methodological limitations noted above, it is important to note that one of the criterion measures, The Test of Problem Solving (TOPS), has been unfavorably reviewed for its psychometric properties [Bernhardt, 1990; Skarakis-Doyle et al., 1991]. It should be noted that for this study high inter-rater agreement (0.96) was obtained from two independent examiners (one obtained from live scoring and the second from scoring via audiotape).

The selection of a language battery capable of sampling important language functions in the adult DS population is problematic. Many measures designed to assess language development at the 5-6 year-old level lack content relevant to adults with DS. For example, the Elementary TOPS-revised [Zachman et al., 1994], has replaced the TOPS. However, we have found that our DS subjects misinterpret many of the TOPS-R pictured scenarios making the language probe irrelevant. Additional development of language measures will be important to isolate pharmacologic effects on language function in the DS population and in other groups with specific language impairments.

Our findings also support our earlier report [Kishnani et al.,2001] that donepezil is relatively well tolerated by DS adults. This finding does contrast with one case study that reported urinary incontinence associated with donepezil in DS patients [Hemingway-Eltomey and Lerner, 1999]. Clearly, larger studies are needed to address this issue more conclusively.

The results of this study raise important questions regarding the role of the cholinergic system in language function and the specific effect of cholinergic therapy in the treatment of language impairment in DS. For individuals with DS, improvements in language usage of the magnitude found in this study can lead to important functional gains in activities of daily living. An improvement in the ability to express ideas and verbally interact with others can lead to better reading and writing skills, improved social relationships, improved mood and emotional stability, increased independence, and improved opportunities for employment. Large-scaled, controlled studies of the effects of donepezil treatment on language and on other cognitive domains in DS are required to address questions regarding the role of the cholinergic system in language function and the specific effect of cholinergic therapy in the treatment of language impairment in DS.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

### References

Beitchman J H, Nair R, Clegg M, & Patel P G. (1986). Prevalence of speech and language disorders in 5-year-old kindergarten children in the Ottawa-Carleton region. Journal of Speech and Hearing. Disorders 51: 98-110.

Benton A. (1964). Developmental aphasia (DA) and brain damage. Cortex 1(1): 40-52.

Bernhardt B. 1990. A test of the Test of Problem Solving. Language, Speech, and Hearing Services in the Schools 21:98-101.

Byrne A, Buckley S, Macdonald J, Bird G. 1995. Investigating the literacy, language and memory skills of children with Down's syndrome. Down's syndrome: Research and Practice 3:53-58.

Capone G T. 2001. Down syndrome: Advances in molecular biology and neurosciences. Developmental and Behavioral Pediatrics 22(1):40-58.

Chapman R S. 1995. Language development in children and adolescents with Down syndrome. In Fletcher P, Macwhinney B, editors. Handbook of child language. Oxford:Blackwell. p 641-663.

Chapman R S. 1997. Language development in children and adolescents with Down syndrome. Mental Retardation and Developmental Disabilities Research Reviews 3:307312.

Chapman R, Schwartz S E, Kay-Raining Bird E. 1991. Language skills of children and adolescents with Down syndrome. I. Comprehension. JSHR 34:1106-1120.

Chapman R, Seung H K, Schwartz S E, Kay-Raining Bird E. 1998. Language skills of children and adolescents with Down syndrome: II. Production deficits. JSHLR 41:861873.

Davis K, Mohs R, Tinklenberg J, Pfefferbaum A, Hollister A, & Kopell B. (1978). Physostigmine: Improvement of long -term memory processes in normal humans. Science 201(4352): 272-274.

Doraiswamy P M. 1996. Current cholinergic therapy for symptoms of Alzheimer's disease. Primary Psychiatry 3(11):3-11.

Drachman D, & Leavitt J. (1974). Human memory and the cholinergic system. Archives of Neurology 30(2): 113-121.

Evans D. 1977. The development of language abilities in mongols: A correlational study. Journal of Mental Deficiency Research 23:103-117.

Fabbretti D, Pizzuto E, Vicari S, Volterra V. 1997. A Story Description Task in Children with Down's Syndrome: Lexical and Morphosyntactic Abilities. Journal of Intellectual Disability Research 41:165-179.

Fowler A E. 1990. Language abilities in children with Down syndrome: evidence for a specific syntactic delay. In Cicchetti D, Beeghly M, editors. Children with Down syndrome: A developmental perspective. Cambridge: Cambridge University. p 302-328.

Hemingway-Eltomey J M, Lerner A J. 1999. Adverse effects of Donepezil in treating Alzheimer's disease associated with Down's syndrome. American Journal of Psychiatry 156(9):1470.

Kishnani P S, Sullivan J A, Walter B K, Spiridighozzi G A, Doraiswamy P M, Krishnan K R R. 1999. Cholinergic therapy for Down's syndrome. Lancet 353:1064-1065.

Kishnani P S, Spiridigliozzi G A, Heller J H, Sullivan J, Doraiswamy P M, Krishnan K R R. 2001. Donepezil for Down syndrome. Am J Psychiatry 158(1):143.

Marcell M M, Ridgeway D, Sewell D H, Whelan M L. (1995). Sentence imitation by adolescents and young adults with Down's syndrome and other intellectual disabilities. J Int Dis Res 39(3):215-232.

McLendon B, Doraiswamy P M. 1999. Defining meaningful change in Alzheimer's disease trials: The donepezil experience. Journal of Geriatric Psychiatry and Neurology 12(1):39-48.

Miller, J F. 1988. The developmental asynchrony of language development in children with Down syndrome. In Nadel L, editor. The Psychobiology of Down Syndrome Cambridge:MIT Press, p 167-198.

Powell, T W. 1993. Factorial validity of the Test of Problem Solving. Perceptual and Motor Skills 76:753-754.

Raskind M A, Sadowsky C H, Sigmund W R, Beitler P J, Auster S B. 1997. Effect of Tacrine on language, praxis and noncognitive behavioral problems in Alzheimer disease. Archives of Neurology 54:836-840.

Richman, L C. (1983). Language learning disability: Issues, research and future directions. Developmental and Behavioral Pediatrics 4: 87-107.

Ripich D N, Carpenter B, Ziol E. 1997. Comparison of African-American and white persons with Alzheimer's disease on language measures. Neurology 48(3):781-783.

Rondal J A, Comblain A. 1996. Language in adults with Down syndrome. Down Syndrome Research and Practice 4(1):3-14.

Rondal J A, Lambert J L, 1983. The speech of mentally retarded adults in a dyadic communication situation: Some formal and informative aspects. Psychologica Belgica 23:49-56.

Sarter M, & Bruno J. (1997). Cognitive functions of cortical acetylcholine: Toward a unifying hypothesis. Brain Research Reviews 23: 28-46.

Semel E, Wiig E, Secord W. 1986. Clinical Evaluation of Language Fundamentals -Revised. San Antonio:The Psychological Corporation.

Skarakis-Doyle E, Mallet C A. 1991,. Test-retest reliability:

Another evaluation of the Test of Problem Solving. Language, Speech, and Hearing Services in the Schools 22:278-279.

Tallal P. (1988). Developmental language disorders. In J K Kavenaugh and T J Truss (Eds.) Pg. 181-272. Leaning disabilities:

Proceedings from the national conference. Parkton, M D: York

Velluntino F R. (1979). Dyslexia: Theory and research. Cambridge: MIT.

Williams D M, Darbyshire J D, & Vaghy D A. (1980). An epidemiological study of speech and hearing disorders. The Journal of Otolaryngology (Supplement) 7:5-24.

Zachman L, Jorgensen C, Huisingh R, Barrett M. 1984. Test of Problem Solving. Moline, I L: Linguisystems.

Zachman L, Huisingh R, Barrett M, Orman J, LoGiudice C. 1994. Elementary Test of Problem Solving-Revised. Moline, I L: Linguisystems.

I/We claim:

1. A method to improve language information processing comprising:
prescribing for a human subject that has a language information processing deficit relative to normal individuals, a dose of an agent which increases acetyl choline or butyryl choline levels in brain, said dose effective to increase specific domains of language performance, wherein said subject does not have Down's Syndrome, schizophrenia, attention deficit hyperactivity disorder, Alzheimer's disease, Parkinson's disease, head injury, dementia, memory deficit, Wernicke-Korsakoff's disease, Tardive Diskenesia, vascular dementia, or depression.

2. A method to improve language information processing, comprising:
administering to a human subject that has a language information processing deficit relative to normal individuals, a dose of an agent which increases acetyl choline or butyryl choline levels in brain, said dose effective to increase specific domains of language performance wherein said subject does not have Down's Syndrome, schizophrenia, attention deficit hyperactivity disorder, Alzheimer's disease, Parkinson's disease, head injury, dementia, memory deficit, Wernicke-Korsakoff s disease, Tardive Diskenesia, vascular dementia, or depression.

3. The method of claim 1 wherein the human subject has a chromosomal disorder.

4. The method of claim 2 wherein the human subject has a chromosomal disorder.

5. The method of claim 3 or 4 wherein the chromosomal disorder is trisomy.

6. The method of claim 3 or 4 wherein the chromosomal disorder is fragile X syndrome.

7. The method of claim 3 or 4 wherein the chromosomal disorder is monosomy.

8. The method of claim 3 or 4 wherein the chromosomal disorder is a translocation.

9. The method of claim 3 or 4 wherein the chromosomal disorder is an abnormal number of triplet repeats.

10. The method of claim 1 or 2 wherein the subject is an adult.

11. The method of claim 1 or 2 wherein the subject is a child.

12. The method of claim 1 or 2 wherein the agent is cholinesterase inhibitor donepezil.

13. The method of claim 1 or 2 wherein the agent is cholinesterase inhibitor tacrine.

14. The method of claim 1 or 2 wherein the agent is cholinesterase inhibitor rivastigmine.

15. The method of claim 1 or 2 wherein the agent is cholinesterase inhibitor galantamine.

16. The method of claim 12 wherein the effective dose is about 1 to 10 mg/day.

17. The method of claim 13 wherein the effective dose is about 10 to 160 mg/day.

18. The method of claim 14 wherein the effective dose is about 0.5 to 15 mg/day.

19. The method of claim 15 wherein the effective dose is about 1 to 25 mg/day.

20. The method of claim 1 or 2 wherein the agent is a cholinergic agonist.

21. The method of claim 1 or 2 wherein the agent is a muscarinic receptor agonist.

22. The method of claim 1 or 2 wherein the agent is a nicotinic receptor agonist.

23. The method of claim 1 further comprising: prescribing educational therapy for said subject.

24. The method of claim 1 or 2 wherein the subject receives educational treatments for a specific learning disability.

25. The method of claim 1 or 2 wherein the subject receives educational treatments for a reading disability.

26. The method of claim 1 further comprising: prescribing language therapy for said subject.

27. The method of claim 1 or 2 wherein the subject receives language treatments.

28. The method of claim 1 further comprising: prescribing expressive language therapy for said subject.

29. The method of claim 1 or 2 wherein the subject receives expressive language treatments.

30. The method of claim 1 or 2 wherein the subject has a reading impairment and said agent increases reading performance.

31. The method of claim 1 or 2 wherein the subject has a pragmatics deficit and said agent increases pragmatics performance.

32. The method of claim 1 or 2 wherein the subject has a problem solving deficit and said agent increases problem solving performance.

33. The method of claim 1 or 2 wherein the subject has an information processing deficit and said agent increases information processing performance.

34. The method of claim 1 or 2 wherein the subject has an adaptive function deficit and said agent increases adaptive function.

35. The method of claim 1 or 2 wherein the subject has a social skills deficit and said agent increases social skills.

36. The method of claim 1 or 2 wherein the subject has an attention deficit and said agent increases attention.

37. The method of claim 1 or 2 wherein the subject has an employment performance deficit and said agent increases employment performance.

38. The method of claim 1 or 2 wherein the subject has a mood deficit and said agent improves mood.

39. The method of claim 1 further comprising the step of: diagnosing a verbal performance deficit prior to the step of prescribing.

40. The method of claim 2 further comprising the step of: diagnosing a verbal performance deficit prior to the step of administering.

41. A kit for treating human subjects to improve language information processing, comprising:
one or more divided or undivided doses of an agent which increases acetyl choline or butyryl choline levels in the brain, said doses effective to improve specific domains of language performance in human subjects; and
printed instructions for prescribing or administering said agent to improve language information processing in human subjects who have a language information processing deficit relative to normal individuals and who do not have Down's Syndrome, schizophrenia, attention deficit hyperactivity disorder, Alzheimer's disease, Parkinson's disease, head injury, dementia, memory deficit, Wernicke-Korsakoff's disease, Tardive Diskenesia, vascular dementia, or depression.

42. The kit of claim 41 wherein the printed instructions and the agent are contained within a single package.

43. The kit of claim 41 wherein the printed instructions are affixed to a package which contains the agent.

44. The kit of claim 41 wherein the printed instructions comprise a reference to an internet site.

45. The kit of claim 41 wherein the agent is cholinesterase inhibitor donepezil.

46. The kit of claim 41 wherein the agent is cholinesterase inhibitor is tacrine.

47. The kit of claim 41 wherein the agent is cholinesterase inhibitor is rivastigmine.

48. The kit of claim 41 wherein the agent is cholinesterase inhibitor is galantamine.
